(19) United States
(12) Patent Application Publication
(10) Pub. No.: US 2019/0392851 A1
(43) Pub. Date: Dec. 26, 2019

(54) ARTIFICIAL INTELLIGENCE-BASED APPARATUS AND METHOD FOR CONTROLLING HOME THEATER SPEECH

(71) Applicant: LG ELECTRONICS INC., Seoul (KR)

(72) Inventors: Kokeun KIM, Seoul (KR); Taeho LEE, Seoul (KR)

(73) Assignee: LG ELECTRONICS INC., Seoul (KR)

(21) Appl. No.: 16/561,794

(22) Filed: Sep. 5, 2019

(30) Foreign Application Priority Data
Aug. 9, 2019 (KR) 10-2019-0097734

(51) Int. Cl. G10L 19/06; G10L 15/22; G10L 25/84; G06N 3/08; G10L 21/12

(52) U.S. Cl. CPC G10L 19/06; G10L 15/22; G10L 21/12; G06N 3/084; G10L 25/84

(57) ABSTRACT

The artificial intelligence (AI)-based apparatus for controlling home-theater speech, which performs separation and synthesis on speech output from an electronic device of a user, includes an input unit that receives the speech, and a processor that separates and extract, from the speech from the input unit, a first signal representing a speech signal related to language or dialogue and a second signal representing a speech signal related to background sound or effect sound; extracts feature vectors of the first signal and the second signal to perform unsupervised learning; and calculates an amplitude difference between the first signal and the second signal according to a result of the unsupervised learning, and adjusting the amplitude difference according to an output method preset by the user.

### CROSS-REFERENCE TO RELATED APPLICATIONS

This application claims priority to Korean Patent Application No. 10-2019-0097734 filed on Aug. 9, 2019 in Korea, the entire contents of which is hereby incorporated by reference in its entirety.

### BACKGROUND

The present invention relates to an artificial intelligence-based apparatus and method for controlling home theater speech. In particular, the present invention relates to a control device capable of being connected to the outside of a home theater to separate and synthesize speech containing various sound sources and a method therefor.

As the number of people who want to enjoy movies and the like with high quality images and sound increases, the importance of more dynamic and realistic speech is increasing day by day. Therefore, a lot of people are spared no expense in purchasing a multi-channel speaker device according to a projection or a large display device, and technology for increasing a user's immersion in communication, broadcasting, and home appliances has been proposed.

A multi-channel audio system generally has audio channels which are separate from each other, and are composed of surround channels in which speech and effect sound are separate, thereby providing excellent realistic reproduction.

However, when most of the audio content is seen through movies on a home theater system connected to a TV, there are many cases in which bass effect sound is very loud, but the volume of dialogue is very small.

In this regard, Korean Patent Publication No. 2019-0027398 (Real Time Sound Source Separation Device and Sound Device) discloses a sound source separation device and a sound device which can separate a plurality of channel sound source signals from an input stereo sound source signal in real time.

However, the prior art is a technology for receiving a stereo sound source signal from a connected sound source terminal and performing separation, and has a problem in that it is hard to separate or synthesize a dialog and an effect sound.

In particular, recently, speech source of 5.1 channels or more is used, and there is a problem that the prior art cannot be applied thereto. Also, there is still a problem to increase the volume when the dialogue comes out, and to reduce the volume when the sound effect or background sound comes out.

### SUMMARY

An object of the present invention is to provide a control device and method for separating and synthesizing a sound source signal and amplifying and synthesizing only a dialogue speech signal desired by a user.

According to an aspect of the present invention, an artificial intelligence (AI)-based method of controlling home theater speech which performs separation and synthesis on sound output from an electronic device of a user includes a first step of receiving the speech and separating and extracting a first signal representing a speech signal related to language or dialogue and a second signal representing a speech signal related to background sound or effect sound; a second step of extracting feature vectors of the first signal and the second signal to perform unsupervised learning; and a third step of calculating an amplitude difference between the first signal and the second signal according to a result of the unsupervised learning, and adjusting the amplitude difference according to an output method preset by the user.

According to an embodiment, the first step may include converting the speech in a time domain into a speech signal in a frequency domain having a plurality of speech frames, and extracting at least one spectrum associated with each of the speech frames of the speech signal in the frequency domain.

According to an embodiment, the first step may include converting the speech in a time domain into a speech signal in a frequency domain, having a plurality of speech frames, and extracting a frequency cluster for the first signal and the second signal by performing separation according to the frequency domain.

According to an embodiment, the second step may include extracting a feature vector considering correlation between time and frequency from the speech, and applying the feature vector to a deep neural network to generate a classification model.

According to an embodiment, the extracting of the feature vector may further include performing a short-term Fourier transform on the speech, generating a vector considering the correlation between the time and the frequency, and calculating a spectral density matrix of the speech through an extended vector.

According to an embodiment, the applying of the feature vector to the deep neural network may include initializing the classification model through a divergence algorithm and performing learning in advance.

According to an embodiment, the third step may further include calculating amplitude spectra of the first signal and the second signal, and calculating a difference between the amplitude spectrum of the first signal and the amplitude spectrum of the second signal.

According to an embodiment, the third step may further include setting, by the user, an amplitude ratio between the first signal and the second signal, and the first signal and the second signal may be speech-synthesized according to the amplitude ratio.

According to another aspect of the present invention, an artificial intelligence (AI)-based apparatus for controlling home-theater speech which performs separation and synthesis on speech output from an electronic device of a user includes an input unit configured to receive the speech; a processor configured to separate and extract, from the speech from the input unit, a first signal representing a speech signal related to language or dialogue and a second signal representing a speech signal related to background sound or effect sound, extract feature vectors of the first signal and the second signal to perform unsupervised learning, and calculate an amplitude difference between the first signal and the second signal according to a result of the unsupervised learning, and adjusting the amplitude difference according to an output method preset by the user.

According to an embodiment, the artificial intelligence-based apparatus may further include an output unit configured to adjust the amplitude difference between the first signal and the second signal and perform output.

According to an embodiment, the processor may convert the speech in a time domain into a speech signal in a frequency domain having a plurality of speech frames and extract at least one spectrum associated with each of the speech frames of the speech signal in the frequency domain; or extract a frequency cluster for the first signal and the second signal by performing separation according to the frequency domain.

According to an embodiment, the processor may extract a feature vector considering correlation between time and frequency from the speech, and apply the feature vector to a deep neural network to generate a classification model.

According to an embodiment, the processor may apply the first signal and the second signal to a deep neural network, and the deep neural network may initialize a classification model through a divergence algorithm and is learned in advance.

According to an embodiment, the processor may calculate amplitude spectra of the first signal and the second signal, and calculate a difference between the amplitude spectrum of the first signal and the amplitude spectrum of the second signal.

According to an embodiment, the processor may speech-synthesize the first signal and the second signal according to an amplitude ratio set by a user.

### BRIEF DESCRIPTION OF THE DRAWINGS

FIG. 1 is a block diagram for describing a learning apparatus of an artificial neural network.

FIG. 2 is a block diagram for describing a configuration of an unsupervised learning system for performing weighting for improvement of speech recognition performance according to an embodiment of the present invention.

FIG. 3 is a diagram for describing a detailed configuration of a processor according to an embodiment of the present invention.

FIG. 4 illustrates a configuration of an artificial intelligence-based apparatus for controlling home theater speech according to an embodiment of the present invention.

FIG. 5 is a flowchart of an artificial intelligence-based method for controlling home theater speech according to an embodiment of the present invention.

FIG. 6 is a detailed flowchart of a first step to a third step of FIG. 5 according to an embodiment of the present invention.

FIG. 7 is a diagram illustrating a speech separation and synthesis process using an artificial intelligence-based apparatus for controlling home theater speech according to an embodiment of the present invention.

FIG. 8 is a diagram illustrating a speech separation and synthesis process using an artificial intelligence-based apparatus for controlling home theater speech according to another embodiment of the present invention.

### DETAILED DESCRIPTION OF THE PREFERRED EMBODIMENTS

Hereinafter, exemplary embodiments of the present invention will be described in detail with reference to the accompanying drawings. However, it will be understood that the present invention is by no means restricted or limited in any manner by these exemplary embodiments. Like reference numerals in the drawings denote members that perform substantially the same function.

The objects and effects of the present invention may be naturally understood or more apparent from the following description and the objects and effects of the present invention are not limited only by the following description. In addition, when it is determined that the detailed description of the known technology related to the present invention may unnecessarily obscure the gist of the present invention in describing the present invention, the detailed description thereof will be omitted.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

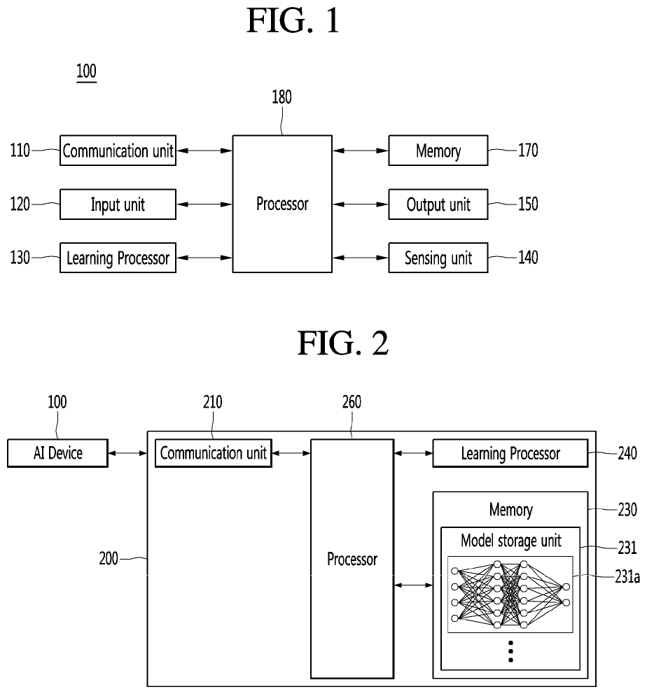

FIG. 1 illustrates an AI device 100 including a robot according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 connected to a robot according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

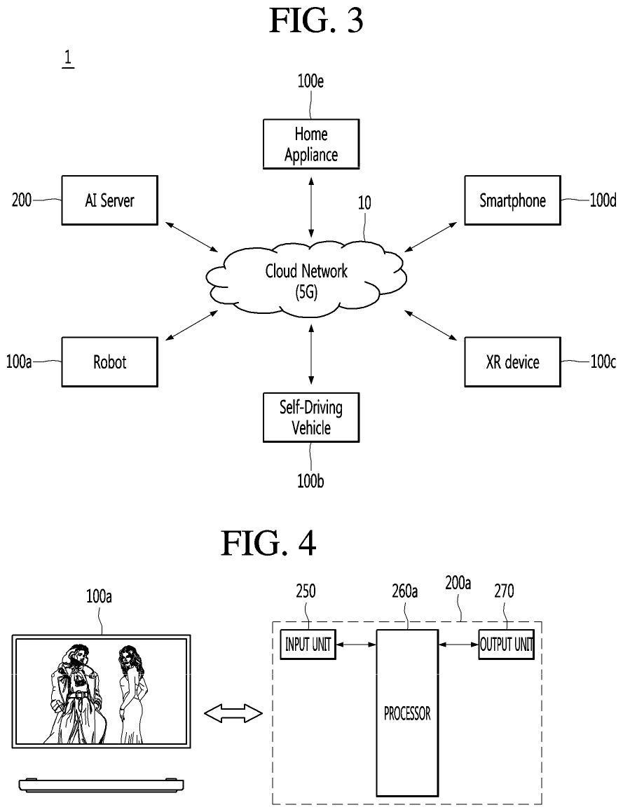

FIG. 3 illustrates an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

FIG. 4 illustrates a configuration of an artificial intelligence-based apparatus for controlling home theater speech according to an embodiment of the present invention.

Referring to FIG. 4, the present invention may include an input unit 250, a processor 260a, and an output unit 270.

The input unit 250 may receive a speech for separating and synthesizing a speech output from an electronic device 100a of a user.

The input unit 250 may record an original sound source produced by a film producer or the speech output from the user's electronic device 100a. The input unit 250 may include an interface such as a microphone to receive the speech of the electronic device 100a.

According to an embodiment, the memory may be included. The memory may include a NAND flash memory, such as a compact flash (CF) card, a secure digital (SD) card, a memory stick, a solid-state drive (SSD), or a micro SD card, a magnetic computer storage device, such as a hard disk drive (HDD), an optical disc drive such as a CD-ROM or a DVD-ROM, and the like.

The processor 260a may execute a program stored in a memory, extract a feature vector from speech data and perform unsupervised learning as the program is executed, and cluster acoustic characteristics selected based on results of the unsupervised learning.

The processor 260a may separate and extract, from the speech of the input unit 250, a first signal representing a speech signal associate with language or dialogue and a second signal representing a speech signal associated with a background sound or an effect sound, extract feature vectors of the first signal and the second signal to perform unsupervised learning, calculate an amplitude difference between the first signal and the second signal according to a result of the unsupervised learning, and adjust the amplitude difference according to an output method previously set by the user.

An object of the present invention is to separate speech signals to modulate a speech amplitude desired by the user or maintain the balance between the separated speeches. The processor 260a performs separation of the first signal and the second signal according to an embodiment of the present invention, but is not limited thereto. The processor 260a may also perform separation into N signals according to frequency characteristics.

The processor 260a may apply a signal separation technique to the frequency domain for each cluster. In this case, signals in the frequency domain of each cluster may be a spectrum of separated signals representing only one sound source for each channel.

The processor 260a may change the speech into a speech signal in a frequency domain having a plurality of speech frames in the time domain and extract at least one spectrum associated with each speech frame of the speech signal in the frequency domain, or extract a frequency cluster for the first signal and the second signal by performing separation according to the frequency domain.

The processor 260a may perform inverse Fourier transform by solving channel swapping caused because a magnitude of a channel becomes different from an original sound source due to the inherent limitation of the signal separation technology, and scaling applied to clusters differently.

The processor 260a may perform inverse Fourier transform, and may separate a frequency domain signal, allocate a channel to represent only one sound source for each input channel, and then reintegrate and restore a speech signal in the time domain.

The present invention may effectively process the recording, transmission and recognition performance by separating the signal of a desired sound source alone in an environment where a plurality of sound sources exist simultaneously in using a device that inputs various sounds including a speech.

According to an embodiment, the first signal and the second signal in the movie are separated. However, the present invention is not limited thereto, and may select and process a desired sound source through recognition, in the environment where many people utter simultaneously, such as a conference hall or the environment where various sound sources exist simultaneously, such as a concert hall.

The processor 260a may extract a feature vector in which correlation between time and frequency is considered from the speech and apply the feature vector to a deep neural network to generate a classification model.

In the case of the first signal and the second signal described above, a frequency band may be clearly separated, and speech amplitudes may be different according to an embodiment of the present invention. According to an embodiment, in the case of an interface such as a microphone provided in the input unit 250, the frequency of a human voice may be 200 Hz to 3 kHz, and the frequency of background sound or effect sound may be separated in a region of 0 Hz to 200 Hz.

The processor 260a may separate the speech signal into a first signal and a second signal, and extract a feature vector for each signal. The processor 260a may separate the first signal and the second signal into frequency bands. Also, the processor 260a may convert each signal into a spectrogram to calculate a feature vector to perform unsupervised learning.

In an embodiment, the processor 260a may extract the converted first signal and second signal into a feature vector of a predetermined time frame unit (for example, 10 ms). Feature vectors may be generated by splicing windows as many as the number of frames, and the generated feature vectors may be used as feature vectors applied to unsupervised learning.

The processor 260a may apply the first signal and the second signal to a deep neural network, and the deep neural network may initialize a classification model through a divergence algorithm and may be pre-learned.

The processor 260a may include a learning unit such as an auto encoder, and may perform unsupervised learning by applying the calculated feature vectors to the deep neural network. The processor 260a may use a stacked autoencoder on the extracted feature vectors to train the feature vectors, and the stacked autoencoder may learn the feature vectors by increasing an intermediate node by one layer.

The processor 260a may calculate amplitude spectra of the first signal and the second signal, and calculate a difference between the amplitude spectrum of the first signal and the amplitude spectrum of the second signal.

According to an embodiment of the present invention, in addition to the learning process, balancing may be attempted by comparing the amplitude spectrum itself of the first signal and the amplitude spectrum of the second signal themselves through the amplitude spectrum.

The processor 260a may quantify the amplitudes of the amplitude spectra of the first signal and the second signal, and adjust the amplitude value of the spectrum of the specific band desired by the user. The processor 260a may perform speech synthesis of the first signal and the second signal according to an amplitude ratio set by the user.

The output unit 270 may adjust and output an amplitude difference between the first signal and the second signal. The output unit 270 outputs a signal synthesized by the processor 260a and may include a speaker or the other sound system among the electronic devices 100a of the user.

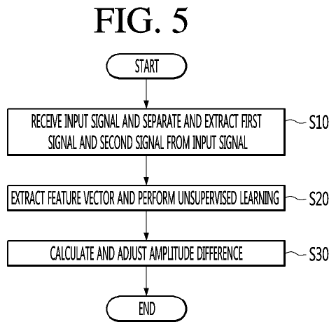

FIG. 5 is a flowchart of an AI-based method for controlling home theater speech according to an embodiment of the present invention.

Referring to FIG. 5, the present invention may include a first step (S10) of receiving a speech and separating and extracting a first signal and a second signal; a second step (S20) of extracting feature vectors and performing unsupervised learning; and a third step (S30) of calculating and adjusting an amplitude difference between the first signal and the second signal.

The first step S10 is a process of receiving the speech and separating and extracting the first signal representing a speech signal related to language or dialogue and a second signal representing a sound signal related to background sound or effect sound.

The processor 260a may perform Fourier transform by dividing a frequency band, and may configure a frequency cluster by combining several frequency bands for input signals for each channel in the frequency domain for each channel.

According to an embodiment of the present invention, the first signal and the second signal may be distinguished, and the processor 260a may configure a frequency cluster such that the signal characteristics in the frequency band are well expressed by a specific probability distribution function and separate signals in the frequency domain.

The second step S20 is a process of performing unsupervised learning by extracting feature vectors of the first signal and the second signal.

The processor 260a may separate the signal in the frequency domain, receive the separated first and second signals, and apply a signal separation technique to the frequency domain of each cluster. In this case, the signals in the frequency domain for each cluster may be a spectrum of separated signals representing only one sound source for each channel.

In the case of the first signal and the second signal, the frequency band may be clearly separated, and speech amplitudes may be different according to an embodiment of the present invention. The processor 260a may separate the speech signal into a first signal and a second signal, and extract a feature vector for each signal.

The processor 260a may apply the first signal and the second signal to a deep neural network, and the deep neural network may initialize a classification model through a divergence algorithm and may be pre-learned. The processor 260a may use a stacked autoencoder on the extracted feature vectors to learn the feature vectors.

The third step S30 is a process of calculating an amplitude difference between the first signal and the second signal according to a result of the unsupervised learning and adjusting the amplitude difference according to an output method set by the user.

The processor 260a may attempt balancing by comparing the amplitude spectra of the first signal and the second signal themselves through the amplitude spectrum in addition to the learning process. The processor 260a may quantify the amplitudes of the amplitude spectra of the first signal and the second signal, and adjust an amplitude value of the spectrum of a specific band desired by the user.

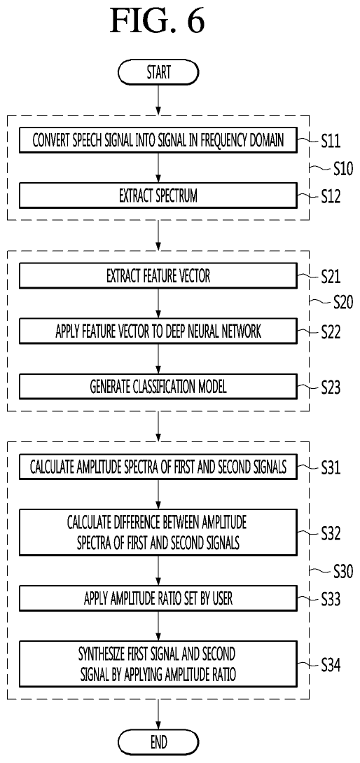

FIG. 6 is a detailed flowchart of the first step S10 to the third step S30 of FIG. 5 according to an embodiment of the present invention.

Referring to FIG. 6, the first step S10 to the third step S30 may include their detailed processes, and in particular, a flowchart of a detailed process of performing separation and synthesis is illustrated in the process of outputting a speech signal received through the input unit 250.

The first step S10 is a process of receiving the speech and separating and extracting a first signal representing a speech signal related to language or dialogue and a second signal representing a sound signal related to background sound or effect sound.

According to an embodiment of the present invention, the first step (S10) may include: converting the speech into a speech signal in the frequency domain having a plurality of speech frames in the time domain (S11); and extracting at least one spectrum associated with each speech frame of the speech signal in the frequency domain (S12).

The processor 260a may separate and extract, from the speech of the input unit 250, a first signal representing a speech signal related to language or dialogue and a second signal representing a speech signal related to background sound or effect sound, extract feature vectors of the first signal and the second signal to perform unsupervised learning, calculate an amplitude difference between the first signal and the second signal according to a result of the unsupervised learning, and adjust the amplitude difference according to an output method set by the user.

The processor 260a may change the speech into a speech signal in a frequency domain having a plurality of speech frames in the time domain and extract at least one spectrum associated with each speech frame of the speech signal in the frequency domain, or extract a frequency cluster for the first signal and the second signal by performing separation according to the frequency domain.

The second step S20 is a process of performing unsupervised learning by extracting feature vectors of the first signal and the second signal.

According to an embodiment, the second step (S20) may include: extracting a feature vector considering a correlation between the time and the frequency from the speech (S21); and applying the feature vector to a deep neural network (S22) to generate a classification model (S23).

The step of extracting the feature vector (S21) may include: performing a short-term Fourier transform on the speech; generating a vector considering the correlation between the time and the frequency; and calculating a spectral density matrix of the speech through an extended vector.

The processor 260a may extract a feature vector for each signal through a sound source separated into the first signal and the second signal. The processor 260a separates signals in frequency bands and converts each signal to calculate a feature vector to perform unsupervised learning.

In addition, the converted first signal and the second signal may be divided in predetermined time frame units and extracted as a feature vector. The processor 260a may generate a feature vector through windowing according to the number of frames.

The process of performing application into the deep neural network may initialize the classification model through a divergence algorithm and may be pre-learned. The processor 260a may perform learning through a learner such as an auto encoder, and perform unsupervised learning by applying the calculated feature vector to a deep neural network.

The third step is a process of calculating the amplitude difference between the first signal and the second signal according to a result of the unsupervised learning, and adjusting the amplitude difference according to an output method preset by the user.

According to an embodiment of the present invention, the processor 260a may calculate an amplitude spectrum of each signal in the learning process, and apply an amplitude ratio value reflecting a weight set by the user to maintain balancing.

The amplitude ratio may be regarded as a factor controlling how much the first signal and the second signal should be output when the first signal and the second signal are synthesized.

The processor 260a may perform speech synthesis of the first signal and the second signal according to the amplitude ratio set by the user.

The third step S30 may include calculating amplitude spectra of the first signal and the second signal (S31); and calculating a difference between the amplitude spectrum of the first signal and the amplitude spectrum of the second signal (S32).

The third step (S30) may include applying an amplitude ratio set by the user to the amplitude ratio of the first signal and the second signal (S33), and applying the amplitude ratio to the first signal and the second signal and outputting the synthesized signal of the first signal and the second signal (S34).

In general, since balancing is maintained when the first signal is heard louder and the second signal is heard smaller, the synthesis may be performed while maintaining a ratio of 7:3 or 6:4 according to an embodiment.

In addition to the above-described ratio, the processor 260a may combine the first signal by 50%, the second signal by 30%, and the other by 20% by considering ratios occupied in the entire sound.

According to an embodiment of the present invention, in addition to the learning process, balancing may be attempted by comparing the amplitude spectra themselves of the first signal and the second signal through the amplitude spectrum.

The processor 260a may quantify the amplitudes of the amplitude spectra of the first signal and the second signal, and adjust an amplitude value of the spectrum of a specific band desired by the user.

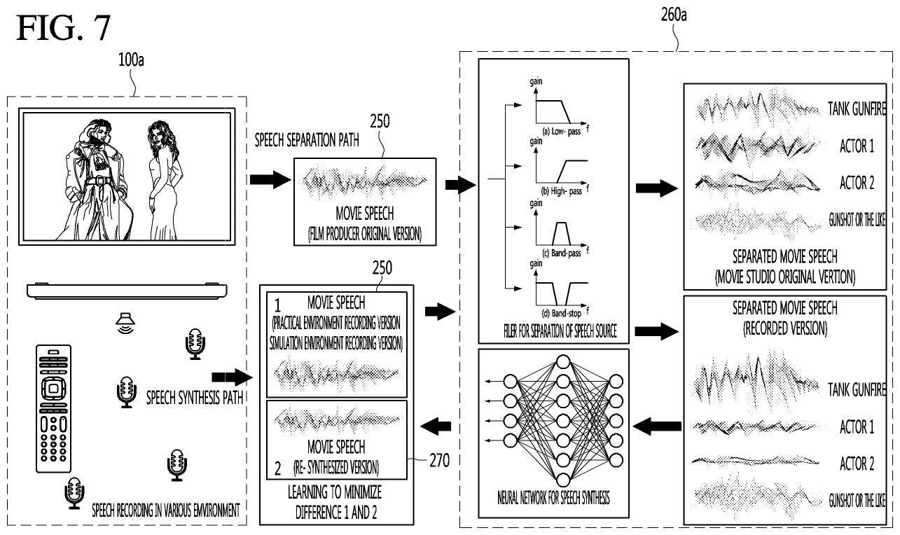

FIG. 7 is a diagram illustrating a speech separation and synthesis process using an artificial intelligence based-apparatus for controlling home theater speech according to another embodiment of the present invention.

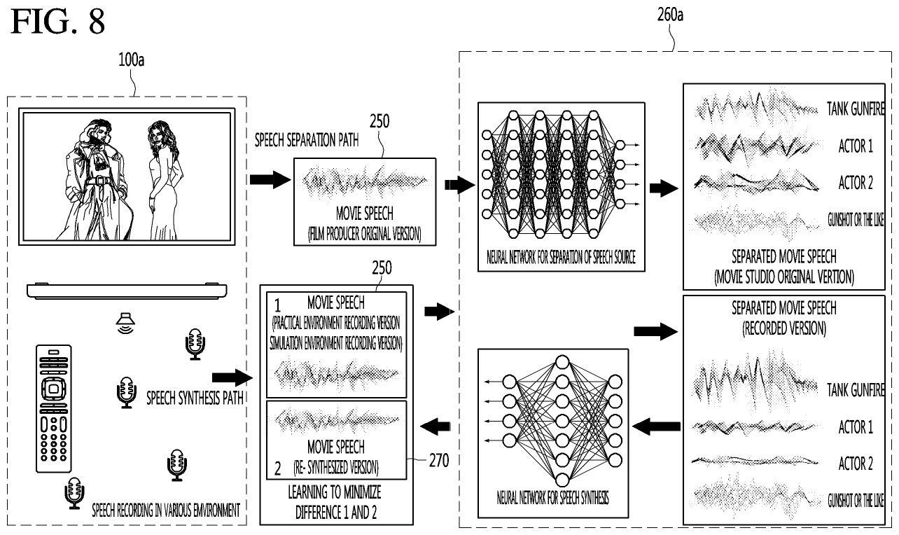

FIG. 8 may differ from FIG. 7 in that a frequency band is separated in a path of separating speech or unsupervised learning. The contents and differences of FIGS. 7 and 8 are the same as those described above.

According to the present invention, synthesized sound is provided while maintaining a balance between a desired signal and an undesired signal from the sound signal, thus allowing a user to view the contents more effectively.

According to the present invention having the above-described configuration, there is an advantage that a user can view the content more effectively since the synthesized speech is provided by maintaining a balance between a desired signal and an undesired signal from the speech signal.

Although the present invention has been described in accordance with the embodiments shown, one of ordinary skill in the art will readily recognize that there could be variations to the embodiments and those variations would be within the spirit and scope of the present invention. Therefore, the scope of the present invention should not be limited to the above-described embodiments but should be determined by not only the appended claims but also all changes or modifications derived from the claims and their equivalents.

What is claimed is:

1. An artificial intelligence (AI)-based method of controlling home-theater speech which performs separation and synthesis on sound output from an electronic device of a user, the AI-based method comprising:
a first step of receiving the speech and separating and extracting a first signal representing a speech signal related to language or dialogue and a second signal representing a speech signal related to background sound or effect sound;
a second step of extracting feature vectors of the first signal and the second signal to perform unsupervised learning; and
a third step of calculating an amplitude difference between the first signal and the second signal according to a result of the unsupervised learning, and adjusting the amplitude difference according to an output method preset by the user.

2. The artificial intelligence-based method of claim 1, wherein the first step includes
converting the speech in a time domain into a speech signal in a frequency domain having a plurality of speech frames, and
extracting at least one spectrum associated with each of the speech frames of the speech signal in the frequency domain.

3. The artificial intelligence-based method of claim 1, wherein the first step includes
converting the speech in a time domain into a speech signal in a frequency domain, having a plurality of speech frames, and
extracting a frequency cluster for the first signal and the second signal by performing separation according to the frequency domain.

4. The artificial intelligence-based method of claim 1, wherein the second step includes
extracting a feature vector considering correlation between time and frequency from the speech, and
applying the feature vector to a deep neural network to generate a classification model.

5. The artificial intelligence-based method of claim 4, wherein the extracting of the feature vector further include
performing a short-term Fourier transform on the speech,
generating a vector considering the correlation between the time and the frequency, and
calculating a spectral density matrix of the speech through an extended vector.

6. The artificial intelligence-based method of claim 4, wherein the applying of the feature vector to the deep neural network includes initializing the classification model through a divergence algorithm and performing learning in advance.

7. The artificial intelligence-based method of claim 1, wherein the third step further includes
calculating amplitude spectra of the first signal and the second signal, and
calculating a difference between the amplitude spectrum of the first signal and the amplitude spectrum of the second signal.

8. The artificial intelligence-based method of claim 7, wherein the third step further includes setting, by the user, an amplitude ratio between the first signal and the second signal,
wherein the first signal and the second signal are speech-synthesized according to the amplitude ratio.

9. An artificial intelligence (AI)-based apparatus for controlling home-theater speech which performs separation and synthesis on speech output from an electronic device of a user, the AI-based apparatus comprising:
an input interface configured to receive the speech;
a processor configured to:
separate and extract, from the speech from the input interface, a first signal representing a speech signal related to language or dialogue and a second signal representing a speech signal related to background sound or effect sound;
extract feature vectors of the first signal and the second signal to perform unsupervised learning; and
calculate an amplitude difference between the first signal and the second signal according to a result of the unsupervised learning, and adjusting the amplitude difference according to an output method preset by the user.

10. The artificial intelligence-based apparatus of claim 9, further comprising:
an output interface configured to adjust the amplitude difference between the first signal and the second signal and perform output.

11. The artificial intelligence-based apparatus of claim 9, wherein the processor is configured to:
convert the speech in a time domain into a speech signal in a frequency domain having a plurality of speech frames and extract at least one spectrum associated with each of the speech frames of the speech signal in the frequency domain; or
extract a frequency cluster for the first signal and the second signal by performing separation according to the frequency domain.

12. The artificial intelligence-based apparatus of claim 9, wherein the processor is configured to:
extract a feature vector considering correlation between time and frequency from the speech; and
apply the feature vector to a deep neural network to generate a classification model.

13. The artificial intelligence-based apparatus of claim 9, wherein the processor is configured to apply the first signal and the second signal to a deep neural network, and
wherein the deep neural network initializes a classification model through a divergence algorithm and is learned in advance.

14. The artificial intelligence-based apparatus of claim 9, wherein the processor is configured to
calculate amplitude spectra of the first signal and the second signal; and
calculate a difference between the amplitude spectrum of the first signal and the amplitude spectrum of the second signal.

15. The artificial intelligence-based apparatus of claim 14, wherein the processor is configured to speech-synthesize the first signal and the second signal according to an amplitude ratio set by a user.
